(19) United States
(12) Patent Application Publication
(10) Pub. No.: US 2006/0196356 A1
(43) Pub. Date: Sep. 7, 2006

(54) Single tower gas dryer with flowing desiccant stream

(76) Inventors: Terry D. Henderson, Naperville, IL (US); Charles A. Henderson, Wheaton, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/346,075

(22) Filed: Feb. 2, 2006

Related U.S. Application Data
(60) Provisional application No. 60/650,319, filed on Feb. 4, 2005.

(51) Int. Cl. B01D 53/06

(52) U.S. Cl. 95/107

(57) ABSTRACT

A gas dryer is provided in which a flowing desiccant stream is utilized. Desiccant is provided in a vessel to dry compressed gas. The vessel includes an inlet for receiving dry desiccant and an outlet for removing wet desiccant from the tower. The desiccant is regenerated as it is transported to the inlet of the vessel.

### RELATED APPLICATION (PRIORITY CLAIM)

This application claims the benefit of U.S. Provisional Application Ser. No. 60/650,391, filed Feb. 4, 2005.

### BACKGROUND OF THE INVENTION

Conventional air/gas dryers are used to remove moisture from a stream of compressed fluid such as air or gas. The conventional dryers include two pressurized vessels or towers. Each of these towers is filled with desiccant for absorbing moisture from the air passed through the tower. In use, the compressed air is processed by a first tower to provide dry compressed air. As the compressed air is processed, the desiccant in the first tower becomes wet and is no longer capable of absorbing moisture from the compressed air. At that time, the flow of compressed air through the first tower is terminated and the air is processed by the second tower. While the compressed air is being processed by the second tower, the desiccant in the first tower is regenerated. When the desiccant in the second tower becomes saturated, the compressed air is again provided to the first tower for processing and the second tower is regenerated.

### OBJECTS AND SUMMARY OF THE INVENTION

A general object of the present invention is to provide an energy efficient dryer.

An object of the present invention is to provide a dryer which can be manufactured cost effectively.

A further object of the present invention is to provide a dryer having a single pressurized tower containing desiccant.

Another object of the present invention is to transport regenerated desiccant to the tower and to remove wet desiccant from the tower.

Yet another object of the present invention is to provide a dryer in which the flow of desiccant through the dryer is nearly continuous.

Yet a further object of the present invention is to provide a dryer which uses a solid desiccant.

A specific object of at least one embodiment of the present invention is provide a dryer which can be used with either a lubricated or non-lubricated compressor.

Briefly, and in accordance with the foregoing, the present invention discloses a single tower air dryer in which solid desiccant is transported to and from the tower. As the desiccant is transported through the dryer it is regenerated.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a diagram of a heat of compression dryer in accordance with an embodiment of the present invention in which the desiccant is indirectly heated;

FIG. 1a is a detailed diagram of the connection between the desiccant supply tube and the de-pressurization tube of the dryer of FIG. 1;

FIG. 2 is a diagram of a heat of compression dryer in accordance with an embodiment of the present invention which can be used in connection with a lubricated compressor;

FIG. 3 is a diagram of a heat of compression dryer in accordance with an embodiment of the present invention in which the desiccant is directly heated;

FIG. 4 is a diagram of a heatless dryer in accordance with an embodiment of the present invention;

FIG. 5 is a diagram of a heated dryer in accordance with an embodiment of the present invention; and

FIG. 6 is a diagram of a dryer in accordance with an embodiment of the present invention in which a portion of the processed air is used to regenerate the desiccant.

### DETAILED DESCRIPTION OF THE ILLUSTRATED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

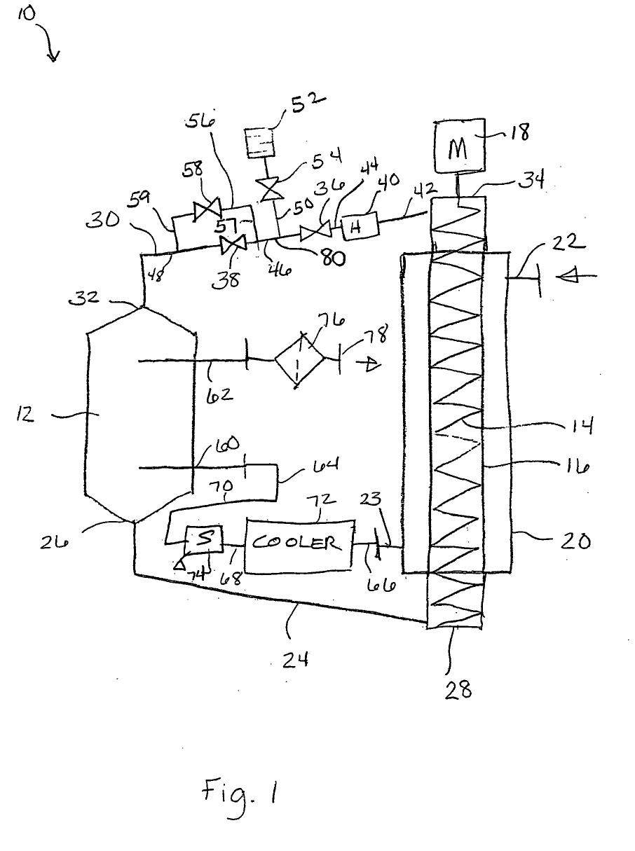

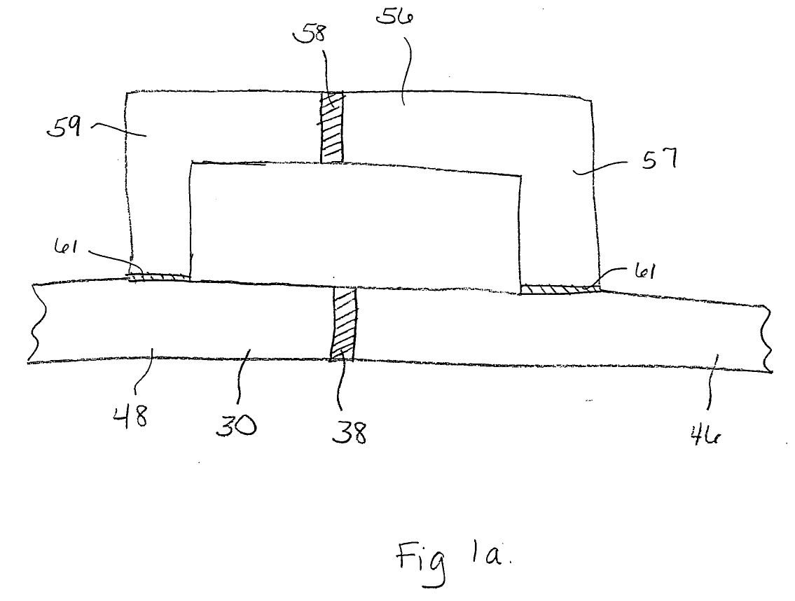

Different embodiments of the invention are shown in each of FIGS. 1-6.

As shown in FIG. 1, the heat of compression dryer 10 includes a standard gas drying vessel or tower 12 and an auger 14. The auger 14 is positioned within an interior pipe 16 and a motor 18 is connected to the auger 14 to rotate the auger 14. It is to be understood that the motor 18 could be connected to the auger at other locations, such as for example, the bottom of the auger 14. The core of the auger 14 may be solid or hollow. The interior pipe 16 and auger 14 are positioned within an exterior pipe or sleeve 20. The exterior pipe or sleeve 20 includes an inlet 22 and an outlet 23. Air from a compressor is received at the inlet 22.

A lower tube or desiccant removal tube 24 connects a bottom end desiccant outlet 26 of the tower 12 to a bottom end 28 of the interior pipe 16 containing the auger 14 and an upper tube or desiccant supply tube 30 connects a top end or desiccant inlet 32 of the tower 12 to a top end 34 of the interior pipe 16 containing the auger 14. The desiccant removal tube 24 is downwardly inclined such that gravity will cause material to flow from the bottom end 26 of the tower 12 to the bottom end 28 of the auger 14. The desiccant supply tube 30 is downwardly inclined such that gravity will cause material to flow from the top end 34 of the auger 14 to the top end 32 of the tower 12.

A desiccant-in valve 36, such as, for example, a rotary lock, a desiccant-out valve 38, such as, for example, a rotary lock, and a heater 40 are mounted along the desiccant supply tube 30. The desiccant supply tube 30 includes a first portion 42, a second portion 44, a third or regeneration portion 46 and a fourth portion 48. The first portion 42 extends from the top end 34 of the interior pipe 16 to the heater 40. The second portion 44 extends from the heater 40 to the desiccant-in valve 36. The third or regeneration portion 46 extends from the desiccant-in valve 36 to the desiccant-out valve 38. The fourth portion 48 extends from the desiccant-out valve 38 to the upper end 32 of the vessel 12.

A muffler tube 50 extends upwardly from the third portion 46 of the desiccant supply tube 30 and provides an outlet for wet gas. A muffler 52 is provided at an end of the muffler tube 50 opposite the third portion 46. A depressurization valve 54 is provided along the muffler tube 50 between the third portion 46 of the desiccant supply tube 30 and the muffler 52.

A re-pressurization tube 56 extends from the third portion 46 of the desiccant supply tube 30 to the fourth portion 48 of the desiccant supply tube 30. A re-pressurization valve 58 is provided along the re-pressurization tube 56. The re-pressurization tube 56 includes a first portion 57 extending from the third portion 46 of the desiccant supply tube 30 to the re-pressurization valve 58 and a second portion 59 extending from the re-pressurization valve 58 to the fourth portion 48 of the desiccant supply tube 30. A detailed view of the connection between the desiccant supply tube 30 and the re-pressurization tube 56 is shown in FIG. 1a. As shown in FIG. 1a, the re-pressurization tube 56 contacts the upper surface of the desiccant supply tube 30. In addition, a screen or filter 61 is provided at either end of the re-pressurization tube 56 to prevent desiccant from entering the re-pressurization tube 56. Preferably, the screen 61 is formed from perforated stainless steel.

As shown in FIG. 1, a chamber 80 is provided by the third portion 46 of the desiccant supply tube 30, the first portion 57 of the re-pressurization tube 56, and the depressurization tube 50.

The tower 12 includes a gas inlet 60 and a gas outlet 62. An incoming tube 64 is provided between the inlet 60 of the tower 12 and the outlet 23 of the outer pipe or sleeve 20. The incoming tube 64 includes a first portion 66, a second portion 68, and a third portion 70. A cooler 72 and a moisture separator 74 are provided along the incoming tube 64. The cooler 72 is positioned between the first portion 66 and the second portion 68 of the incoming tube 64. The moisture separator 74 is positioned between the second portion 68 and the third portion 70 of the incoming tube 64. Drain traps are attached to the separator 74 to remove liquid water from the dryer.

An after filter 76 is provided at the outlet 62 of the tower 12 and the dryer outlet 78 is provided by the after filter 76.

In operation, desiccant flows throughout the dryer 10. The desiccant in tower 12 adsorbs moisture from gas suppled to the tower 12 through the inlet 60. Dried gas exits the tower 12 at the outlet 62. Wet desiccant generally flows from the bottom end 26 of the tower 12 through the desiccant removal tube 24 to the bottom end 28 of the interior pipe 16. The auger 14 carries the wet desiccant upward to the top end 34 of the interior pipe 16. The desiccant exits the top end 34 of the interior pipe 16 and flows through the desiccant supply tube 30 to the top end 32 of the tower 12. Hot compressed air is provided to the outer sleeve 20, through the inlet 22, where heat from the compressed air heats the desiccant within the interior pipe 16 and air surrounding the desiccant as the auger 14 moves the desiccant upwardly through interior pipe 16. If the auger 14 has a hollow core, hot air can be provided to the core of the auger to further heat the desiccant as it moves upwardly through the interior pipe 16. The heated desiccant then flows through the desiccant supply tube 30 toward the upper end 32 of the tower 12. Before reaching the upper end 32 of the tower 12, a pressurizing and de-pressurizing cycle is carried out by the valves 36, 38, 54, 58 to remove moisture from the heated desiccant before it flows into the tower 12.

Hot wet desiccant exits the upper end 34 of the auger 14 and flows through the first portion 42 of the desiccant supply tube 30 and is passed through the heater 40. The heater 40 is an optional auxiliary heater which can be used to raise the temperature of the desiccant to temperatures higher than possible through the inlet gas alone. The moisture is removed from the desiccant during the depressurizing-re-pressurizing cycle.

Cycling of the valves begins with the desiccant-in, desiccant-out, and depressurization valves 36, 38, 54 in the closed position and the re-pressurization valve 58 in the open position. The desiccant-out valve 38 is then opened to allow the desiccant in the third or regeneration portion 46 of the desiccant supply tube 30 to flow into the tower 12. The desiccant-out valve 38 and the re-pressurization valve 58 are then closed. Next, the desiccant-in valve 36 is opened to allow wet desiccant to enter the third or regeneration portion 46 of the desiccant supply tube 30. Because the re-pressurization tube 56 is positioned above the desiccant supply tube 30, desiccant does not flow from the desiccant supply tube 30 into the re-pressurization tube 56. The desiccant-in valve 36 is then closed to isolate the desiccant in the third portion 46 of the desiccant supply tube 30. The depressurization valve 54 is opened, depressurizing the air in the regeneration portion 46 of the desiccant supply tube 30. The re-pressurization valve 58 is then opened and dry, compressed air flows from the upper end 32 of the vessel 12, through the fourth portion 48 of the desiccant supply tube 30, through the second portion 59 of the re-pressurization tube 56, through the repressurization valve 58, through the regeneration portion 46 of the desiccant supply tube 30 and through the depressurization valve 54 to remove moisture from the chamber 80 and to vent the moisture through the muffler or wet gas outlet 52. The amount of time the repressurization valve 58 remains open can be varied. The filter 61 mounted between the fourth portion 48 of the desiccant supply tube 30 and the second portion 59 of the re-pressurization tube 56 prevents desiccant from entering the re-pressurization tube 56. The de-pressurization valve 54 is then closed to re-pressurize the chamber 80. The desiccant-out valve 38 is opened and dry desiccant is provided to the tower 12 and the cycle begins again. This depressurizing-re-pressurizing cycle removes the moisture from the desiccant and the air surrounding the desiccant and occurs approximately every 5 seconds. The length of time of this cycle, can be adjusted for the particular cycle desired.

The dried desiccant passes through the desiccant-out valve 38 to the upper end 32 of the tower 12. Compressed air exits the outer pipe 20 at the outer pipe outlet 23 where it is carried to the cooler 72 and then to the moisture separator 24 prior to entering the tower 12. The compressed air enters the tower 12 through the tower inlet 60 and exits the tower 12 at the tower outlet 62. As the compressed air is passed through the tower 12, the desiccant within the tower 12 removes moisture from the air. Upon exiting the tower 12 through the tower outlet 62 the air is passed through an after filter 76 to remove any particles of desiccant from the air. Dry processed compressed air is provided at the outlet of the after filter 76.

As the desiccant moves through the tower 12, the desiccant becomes wet and it can no longer effectively remove moisture from the air within the tower 12. The wet desiccant exits the desiccant outlet 26 of the tower 12 and flows through the desiccant removal tube 24 to the lower end 28 of the interior pipe 16. Heat from the compressed air which enters the outer pipe 20, heats the interior pipe 16 and desiccant within the interior pipe 16 and the auger 14 carries the desiccant upward through the interior pipe 16 to the top end 34 thereof. The desiccant is then passed through the depressurization-re-pressurization cycle to complete the regeneration of the desiccant.

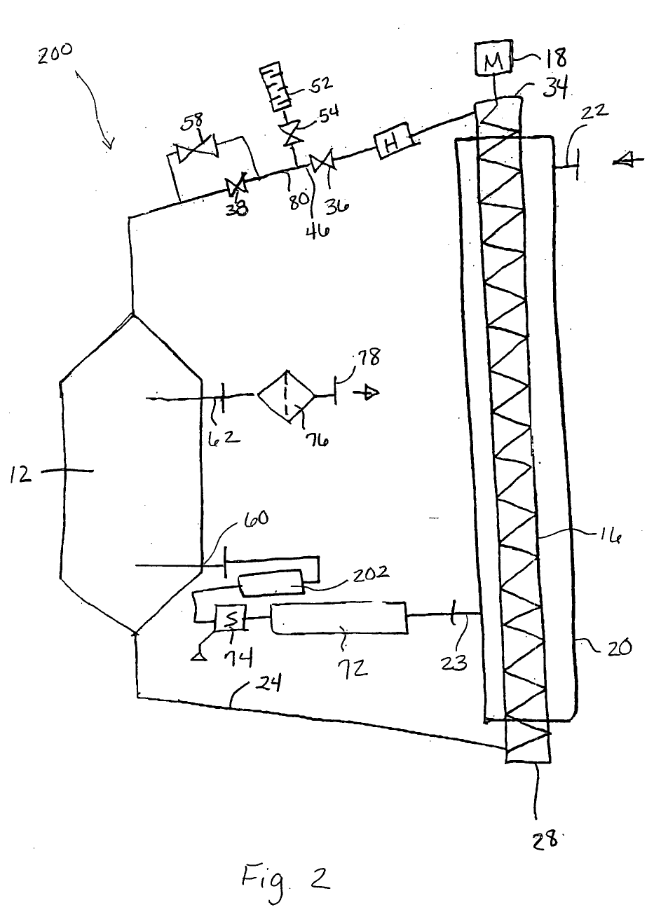

A second embodiment of the invention is shown in FIG. 2. The dryer 200 is identical to the dryer 10 with the following exception. The dryer 200 includes a coalescing pre-filter 202 between the moisture separator 74 and the tower inlet 60. With the coalescing pre-filter 202, the dryer 200 can be used in connection with a lubricated compressor. When a lubricated compressor is attached to the dryer inlet 22, the pre-filter 202 removes oil from the air after the air has been cooled by the cooler 72 and processed by the moisture separator 74 and before the air enters the tower 12.

Compressed air enters the inlet 22 of the exterior pipe 20 from a lubricated compressor (not shown). The wall of the interior pipe 16, prevents the compressed air from contacting the desiccant within the interior pipe 16 as the auger 14 carries the desiccant upward through the interior pipe 16. Although the compressed air does not contact the desiccant within the interior pipe 16, heat from the compressed air is carried to the desiccant through the wall of the interior pipe 16. Compressed air exits the exterior pipe 20 at the outlet 23 where it is then passed through the cooler 72, the moisture separator 74, the pre-filter 202, and then to the inlet 60 of the tower 12. The pre-filter 202 acts to remove oil from the compressed gas before the compressed gas enters the tower 12 and contacts the desiccant.

Use of an oil flooded or lubricated compressor in comparison to an non-lubricated compressor reduces the amount of energy required to regenerate the desiccant. Removing oil from air at high temperatures can be difficult. However, because the temperature of the air is reduced prior to passing the air through the pre-filter 202, the oil can be removed from the air without the complications associated with removing oil from the air at higher temperatures.

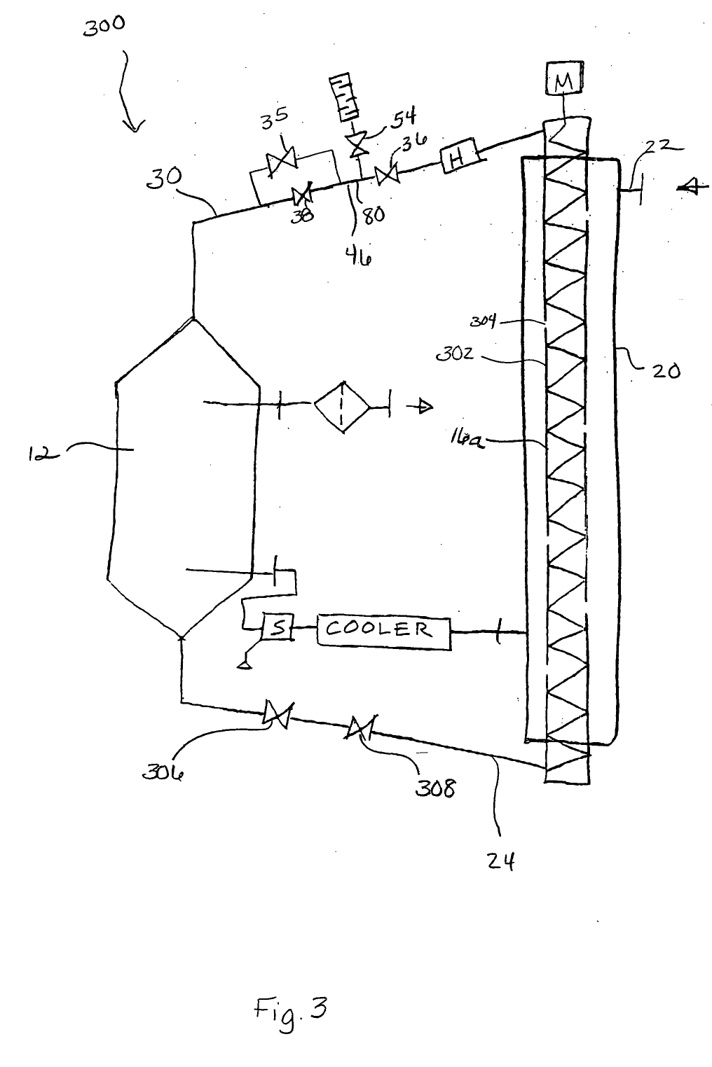

A third embodiment of the dryer is shown in FIG. 3. The dryer 300 is identical to the dryer 10 shown in FIG. 1 with the following exceptions. Unlike the dryer 10 which includes an interior pipe 16 formed from a solid wall. The wall 302 of the interior pipe 16a is perforated. Thus, a plurality of holes 304 are dispersed along the wall 302. In addition, the dryer 300 includes valves or rotary locks 306, 308 along the lower tube 24. The rotary locks 306, 308 operate in the same sequence as the desiccant-in and desiccant-out valves 36, 38. Thus, when desiccant-in valve 36 is open, valve 306 is open. When desiccant-in valve 36 is closed, valve 306 is closed. When desiccant-out valve 38 is open, valve 308 is open and when desiccant-out valve 38 is closed, valve 308 is closed.

In operation, as compressed air enters the inlet 22 of the exterior pipe 20, the compressed air passes through the holes 304 of the wall 302 of the interior pipe 16 and comes in direct contact with the desiccant being carried upward by the auger 14. The desiccant within the interior pipe 16a, therefore, is directly heated by the compressed air.

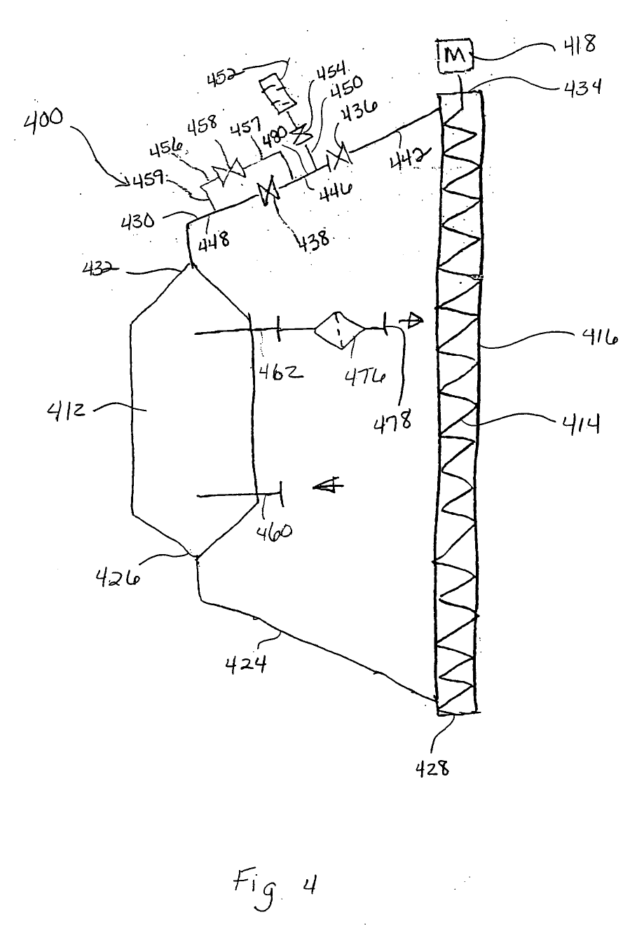

A fourth embodiment of the dryer is shown in FIG. 4. As shown in FIG. 4, the dryer 400 is a heatless model. The dryer 400 includes a standard gas drying vessel 412 and an auger 414. The auger 414 is positioned within a pipe 416 and a motor 418 is connected to the auger 414 to rotate the auger 414. A lower tube or desiccant removal tube 424 connects a bottom end or desiccant outlet 426 of the tower 412 to a bottom end 428 of the pipe 416 containing the auger 414 and an upper tube or desiccant supply tube 430 connects a top end or desiccant inlet 432 of the tower 412 to a top end 434 of the pipe 416 containing the auger 414. The lower tube 424 is downwardly inclined such that gravity will cause the material to flow from the bottom end 426 of the tower 412 to the bottom end 428 of the pipe 416. The desiccant supply tube 430 is downwardly inclined such that gravity will cause material to flow from the top end 434 of the auger 414 to the top end 432 of the tower 412.

A desiccant-in valve 436 and a desiccant-out valve 438 are mounted along the desiccant supply tube 430. The desiccant supply tube 430 includes a first portion 442, a second or regeneration portion 446, and a third portion 448. The first portion 442 extends from the top end 434 of the pipe 416 to the desiccant-in valve 436. The second portion 446 extends from the desiccant-in valve 436 to the desiccant-out valve 438. The third portion 448 extends from the desiccant-out valve 438 to the top end 432 of the tower 412.

A muffler tube 450 extends upwardly from the second or regeneration portion 446 of the desiccant supply tube 430. A muffler 452 us provided at the end of the muffler tube 450 opposite the second portion 446 of the desiccant supply tube 430. A depressurization valve 454 is provided along the muffler tube 450 between the second portion 446 of the desiccant supply tube 430 and the muffler 452.

A re-pressurization tube 456 extends from the second portion 446 of the desiccant supply tube 430 to the third portion 448 of the desiccant supply tube 430. The re-pressurization tube 456 includes a first portion 457 and a second portion 459. A re-pressurization valve 458 is provided between the first portion 457 and the second portion 459 of the re-pressurization tube 456. In the same manner as described with respect to the first embodiment of the invention, the re-pressurization tube 456 contacts the upper surface of the desiccant supply tube 430 to prevent desiccant from entering the re-pressurization tube 456.

A chamber 480 is provided by the second portion 446 of the desiccant supply tube 430, the first portion 457 of the re-pressurization tube 456, and the depressurization tube 450.

The tower 412 includes a gas inlet 460 and a gas outlet 462. An after filter 476 is provided at the outlet 462 of the tower 412 and the dryer outlet 478 is provided by the after filter 476.

In operation, desiccant flows throughout the dryer 400. The desiccant generally flows from the bottom end or desiccant outlet 426 of the tower 412, through the lower tube 424, to the bottom end 428 of the auger 414. The auger 414 carries the desiccant upward to the top end 434 of the auger 414. The desiccant exits the top end 434 of the auger 414, flows through the desiccant supply tube 430 to the top end or desiccant inlet 432 of the tower 412. Before reaching the tower 412, a pressurizing-de-pressurizing cycle identical to the pressurizing-de-pressurizing cycle described in connection with the first embodiment of the invention is carried out by the valves 436, 438, 454, and 458 to remove moisture from the desiccant before it flows into the tower 412.

The dried desiccant passes through the desiccant-out valve 438 to the upper end 432 of the tower 412. Compressed air enters the tower 412 through the tower inlet 460 and exits the tower 412 at the tower outlet 462. As the compressed air is passed through the tower 412, the desiccant within the tower 412 removes moisture from the air. Upon exiting the tower 412 through the tower outlet 462 the air is passed through an after filter 476 to remove any particles of desiccant from the gas. Dry processed compressed gas is provided at the outlet 478 of the after filter 476. If the dryer 400 is to be used in connection with a lubricated compressor, a coalescing pre-filter and a cooler can be provided at the tower inlet 460 to remove any oil from the compressed air.

As the desiccant moves through the tower 412, the desiccant becomes wet and it can no longer effectively remove moisture from the air within the tower 412. The wet desiccant exits the lower end 426 of the tower 412 and flows through the lower tube 424 to the lower end 428 of the pipe 416. The auger 414 carries the desiccant to the upper end 434 of the pipe 416. The desiccant is then passed through the depressurization-re-pressurization cycle to complete the regeneration of the desiccant.

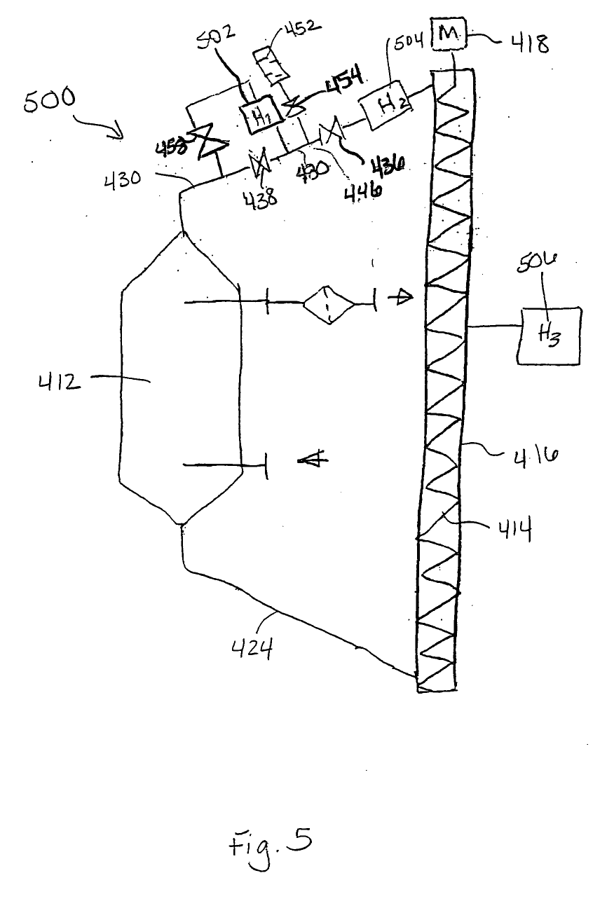

A fifth embodiment of the dryer is shown in FIG. 5. As shown in FIG. 5, the dryer 500 is a heated model. The dryer 500 is identical to the dryer 400 with the following exceptions. The dryer 500 includes a heater. Three alternative locations (502, 504, 506) for the heater are shown in FIG. 5. Alternatively, heaters may be used at multiple locations.

Heater 502 is positioned between the re-pressurization valve 458 and the second portion 446 of the desiccant supply tube 430. As with the dryer 400, a depressurization-re-pressurization cycle of the valves 436, 438, 454, and 458 is used to removed moisture from the air and desiccant within the chamber 480. During the re-pressurization portion of the cycle (i.e. when the desiccant-in, desiccant-out, and depressurization valves 436, 438, 454 are closed and the re-pressurization valve 458 is opened, the heater 502 is used to raise the temperature of the air within the chamber 480 to approximately 300 degrees Fahrenheit. By increasing temperature of the air within the chamber 480, the length of time need to dry the desiccant within the chamber 480 is reduced relative to the dryer 400.

Heater 504 is positioned between the upper end of the pipe 416 and the desiccant-in valve 436. In this location the heater 504 is used to raise the temperature of the desiccant prior to the desiccant entering the chamber 480.

Heater 506 is positioned along the wall of the pipe 416 containing the auger 414. In this location, the desiccant is heated as it is moved upwardly within the pipe 416.

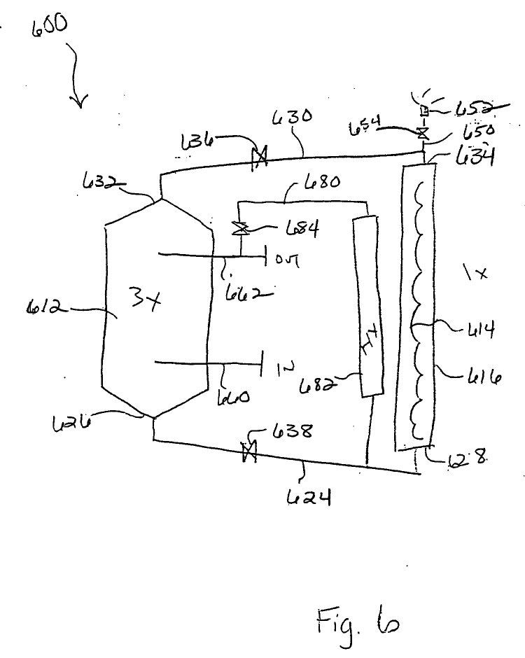

A sixth embodiment of the dryer is shown in FIG. 6. As shown in FIG. 6, the dryer 600 includes a tower 612, an auger 614, a pipe 616, a heater 682, an desiccant supply tube 630, a lower tube 624, and a muffler 652.

The tower 612 has an upper end or desiccant inlet 632 and a lower end or desiccant outlet 626. The tower 612 also includes a gas inlet 660 and a gas outlet 662. The pipe 616 has an upper end 634 and a lower end 628. The auger 614 is provided within the pipe 616. A muffler tube 650 extends from the upper end of the pipe 616 and a muffler 652 is provided at the outer end of the muffler tube 650. A depressurization valve 654 is provided along the muffler tube 650 between the muffler 652 and the upper end 634 of the pipe 616.

The upper tube or desiccant supply tube 630 extends from the upper end 634 of the pipe 616 to the upper end or desiccant inlet 632 of the tower 612. The desiccant supply tube 630 is downwardly inclined such that gravity causes material to flow from the upper end 634 of the pipe 616 through the desiccant supply tube 630 to the upper end 632 of the tower 612. A desiccant-in valve 636 is provided along the desiccant supply tube 630. The lower tube 624 is downwardly inclined such that gravity causes material to flow from the lower end 626 of the tower 612 to the lower end 628 of the pipe 616. A desiccant-out valve 638 is provided along the lower tube or desiccant removal tube 624.

A dried gas tube 680 is provided from the outlet 662 of the tower 612 to the desiccant removal tube 624. The heater 682 is provided along the dried gas tube 680. A dried gas valve 684 is provided between the outlet 662 of the tower 612 and the heater 682.

In operation, compressed air is supplied through the inlet 660 to the tower 612 where the air is dried by desiccant provided within the tower 612. The dry processed air exits the tower 612 at the tower outlet 662. Processed air is also passed through the dried gas valve 684, through the dried gas tube 680, and to the heater 682 where the air is heated. The heated air is then supplied to the desiccant removal tube 624 and is then passed to the lower end 628 of the pipe 616. The auger 614 within the pipe 616 carries the desiccant upward through the pipe 616 to fill the pipe 616. As the desiccant is heated, moisture in the desiccant forms steam. The steam passes through the muffler tube 650, through the depressurization valve 654, and through the muffler 652 where it is vented to the atmosphere. The dried, regenerated desiccant flows out of the top end 634 of the pipe 616 through the desiccant supply tube 630 and to the top end 632 of the tower 612 where it is again used to dry the compressed air.

Sequencing of the valves 636, 638, 650 and 684 results in processing of the desiccant in a batch fashion. Sequencing of the valves is as follows. The cycle begins with the desiccant-in and desiccant-out valves 636, 638 in the open position and depressurization valve 654 and the heater valve 684 in the closed positions. The desiccant-in valve 636 and the desiccant-out valve 638 remain open for a period of time to allow desiccant to fill the pipe 616. Once the pipe 616 is full, the desiccant-in and desiccant-out valves 636, 638 are closed, and the depressurization valve 650 is opened to depressurize the pipe 616. Next, the dried gas valve 684 is opened to begin regeneration of the desiccant within the pipe 616. At this time, the heater is turned on and the auger is turned off. Dry air from the outlet 662 of the tower 612 is provided to the heater 682 and is passed to the pipe 616 where it regenerates the desiccant within the pipe 616. Hot moist air exits the pipe 616, through the muffler tube 650, and is vented to the atmosphere through the muffler 652. Once the desiccant in the pipe 616 is regenerated, the depressurization valve 654 is closed and heater valve 684 is closed. Finally, the desiccant-in and desiccant-out valves are opened to begin the cycle again.

While preferred embodiments of the present invention are shown and described, it is envisioned that those skilled in the art may devise various modifications of the present invention without departing from the spirit and scope of the attached claim.

The invention claimed is:

1. An apparatus for drying gas, comprising:
desiccant for removing moisture from said gas;
a vessel having a gas inlet for receiving gas to be dried, a gas outlet for supplying dried gas, a desiccant inlet for receiving dry desiccant, and a desiccant outlet for removing wet desiccant;
means for transporting desiccant from said desiccant outlet of said vessel to said desiccant inlet of said vessel;
a desiccant drying chamber in communication with said means for transporting; and
a wet gas outlet in communication with said desiccant drying chamber.

2. An apparatus as defined in claim 1, wherein said means for transporting includes a desiccant supply tube in communication with said desiccant inlet of said vessel.

3. An apparatus as defined in claim 2, wherein said desiccant supply tube provides at least a portion of said drying chamber.

4. An apparatus as defined in claim 3, further including a repressurization tube in communication with said desiccant supply tube and wherein a portion of said drying chamber is provided by said repressurization tube.

5. An apparatus as defined in claim 4, wherein said repressurization tube includes first and second ends in communication with an upper portion of said desiccant supply tube.

6. An apparatus as defined in claim 5, wherein a first filter is provided between said first end of said repressurization tube and said desiccant supply tube and wherein a second filter is provided between said second end of said repressurization tube and said desiccant supply tube.

7. An apparatus as defined in claim 3, further including a desiccant-in valve and a desiccant-out valve mounted to said desiccant supply tube and wherein said portion of said drying chamber provided by said desiccant supply tube is defined by said desiccant-in valve and said desiccant out valve.

8. An apparatus as defined in claim 4, further including a repressurization valve in communication with said repressurization tube.

9. An apparatus as defined in claim 3, wherein said wet gas outlet is in communication with said desiccant supply tube.

10. An apparatus as defined in claim 9, further including a depressurization valve mounted between said desiccant supply tube and said wet gas outlet.

11. An apparatus as defined in claim 1, wherein said desiccant drying chamber further includes a heater.

12. An apparatus as defined in claim 1, wherein dry gas is provided to said desiccant drying chamber through said desiccant inlet of said vessel.

13. An apparatus as defined in claim 1, wherein dry gas is provided to said desiccant drying chamber from said gas outlet of said vessel.

14. An apparatus as defined in claim 1, wherein said means for transporting desiccant includes an auger positioned within a pipe having first and second ends, a desiccant supply tube in communication with said first end of said auger and said desiccant inlet of said vessel, and a desiccant exit tube in communication with said second end of said auger and said desiccant outlet of said vessel.

15. An apparatus as defined in claim 14, further including an auger sleeve having a gas inlet and a gas outlet and wherein said gas inlet of said vessel is in communication with said gas outlet of said auger sleeve.

16. An apparatus as defined in claim 15, further including a cooler and a moisture separator positioned between said auger sleeve gas outlet and said gas inlet of said vessel.

17. An apparatus as defined in claim 15, further including a coalescing pre-filter positioned between said auger sleeve gas outlet and said gas inlet of said vessel.

18. An apparatus as defined in claim 15, wherein said pipe is perforated.

19. An apparatus as defined in claim 1, further including a heater in communication with said means for transporting.

20. An apparatus as defined in claim 14, further including a heater in communication with said pipe.

21. An apparatus as defined in claim 14, further including a heater in communication with said desiccant supply tube.

22. An apparatus as defined in claim 14, wherein said first end of said auger is higher than said desiccant inlet of said vessel and said second end of said auger is lower than said desiccant outlet of said vessel.

23. An apparatus as defined in claim 1, wherein a dried gas tube in communication with said gas outlet of said vessel and said means for transporting provides at least a portion of said desiccant drying chamber.

24. An apparatus as defined in claim 14, wherein a dried gas tube in communication with said gas outlet of said vessel and said desiccant removal tube provides at least a portion of said desiccant drying chamber.

25. An apparatus a defined in claim 24, further including a heater in communication with said dried gas tube.

26. A method of drying compressed gas and regenerating desiccant comprising the steps of:
providing a vessel having a desiccant inlet, a desiccant outlet, a wet gas inlet and a dried gas outlet;
providing desiccant in said vessel;
providing wet compressed gas to said vessel;
removing wet desiccant from said desiccant outlet of said vessel;
transporting said wet desiccant to said desiccant inlet of said vessel;
drying said wet desiccant as it is transported;
removing wet gas; and
supplying dried desiccant to said desiccant inlet of said vessel.

27. A method as defined in claim 26, wherein said step of transporting includes the steps of:
providing an auger positioned within a pipe having first and second ends;
transporting said desiccant from said desiccant outlet of said vessel to said first end of said pipe;
rotating said auger; and
transporting said desiccant from said second end of said pipe to said desiccant inlet of said vessel.

28. The method as defined in claim 27, further including the steps of heating said desiccant within said pipe.

29. The method as defined in claim 27, further including the steps of providing a desiccant supply tube positioned between said second end of said pipe and said desiccant inlet of said vessel and providing a desiccant removal tube positioned between said desiccant outlet of said vessel and said first end of said pipe.

30. The method of claim 28, wherein in said desiccant is heated with said wet compressed gas prior to providing said gas to said vessel.

31. The method of claim 30, further including the step of cooling said wet compressed gas and and passing said cooled compressed gas through a moisture separator prior to providing said gas to said gas inlet of said vessel.

32. The method of claim 27, further including the step of providing apertures through said pipe, and providing a sleeve around said pipe.

33. The method of claim 32, further including the step of filtering said gas prior to providing said gas to said inlet of said vessel.

34. The method of claim 26, wherein said step of drying includes providing gas from said gas outlet of said vessel to said wet desiccant.

35. The method of claim 26, wherein said step of drying includes providing gas from said desiccant inlet of said vessel to said wet desiccant.

36. The method of claim 35, further including the steps of:
providing a desiccant supply tube for supplying dried desiccant to said desiccant inlet;
providing a repressurization tube in communication with said desiccant supply tube;
isolating a portion of said wet desiccant within said desiccant supply tube;
providing dry gas to said isolated portion to dry said isolated portion; and
transporting said dried portion of said desiccant to said desiccant inlet of said vessel.

37. The method of claim 37, wherein said step of drying further includes providing a dried gas outlet tube in communication with said gas outlet and said first end of said pipe.

38. The method of claim 37, further including providing a heater in communication with said dried gas outlet tube.
